(19) United States
(12) Patent Application Publication
(10) Pub. No.: US 2016/0335251 A1
(43) Pub. Date: Nov. 17, 2016

(54) NEWINFO, A Computer System for Automated Reasoning to find new information in Natural Language Sentences

(71) Applicant: Hristo Georgiev, Walenstadt (CH)

(72) Inventor: Hristo Georgiev, Walenstadt (CH)

(21) Appl. No.: 14/708,334

(22) Filed: May 11, 2015

(51) Int. Cl. G06F 17/27; G06F 17/28

(52) U.S. Cl. CPC G06F 17/2785; G06F 17/28; G06F 17/274; G06F 17/2755; G06F 17/271

(57) ABSTRACT

Using Natural Language Text Processing techniques, the meaning of a newly written sentence is understood, paraphrased, inferences are made, if needed, and then matched with the meaning of the sentences already written and stored in the System. In the end, the new information found in the newly written sentence is displayed.

### (b) CROSS-REFERENCES TO RELATED APPLICATIONS

Prior applications (pending):
Application Ser. No. 13/198,392, publication No US20130035928A1, Feb. 7, 2013
Application Ser. No. 13/553,950, publication No US 20140025366 A1, 23 Jan. 2014

### (c) STATEMENT REGARDING FEDERALLY SPONSORED RESEARCH OR DEVELOPMENT

There is no federally sponsored research or development.

### (d) NAMES OF THE PARTIES TO A JOINT RESEARCH AGREEMENT

There are no parties to a joint research agreement.

### (e) INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

No material is submitted neither via EFS-WEB nor by post.

### (f) STATEMENT REGARDING PRIOR DISCLOSURES BY THE INVENTOR OR JOINT INVENTOR

The invention was not patented or described in a printed publication in this or a foreign country or in public use or on sale in this country, more than one year prior to the date of application for patent in the United States.

### (g) BACKGROUND OF THE INVENTION

(1) Technical Field(s) of the Invention

Natural Language Text Processing, Artificial Intelligence, Search Engines.

Natural Language Text Processing is a complex process, involving a number of interdependent processes, such as morphological, grammatical, syntactical and semantical analysis of the sentence.

(2) Background Art

The invention is based on previous research, by the author(s), in Natural Language text Processing, without which the invention would not have been possible to realize. For detailed description of the previous research involved, please, see below a patent and a list of publications related to the invention.

Patent: U.S. Pat. No. 8,560,305 B1, published on Oct. 15, 2013, LOGIFOLG, A Computer System for Automated Reasoning to find implicit information in Natural Language Sentences. Instructions 3, 4 and 5 of the procedure presented further below are used by our computer system for Automated Reasoning to find implicit information in Natural Language Sentences. New information is sought also in the implicit information.

1. “Language Engineering”, by Hristo Georgiev, published by The Continuum International Publishing Group Ltd. London—New York, 2007, ISBN: HB: 0-8264-8294-5

2. “English Algorithmic Grammar”, by Hristo Georgiev, published by The Continuum

International Publishing Group Ltd. London—New York, 2006, ISBN 0-8264-8777-7

3. “Dictionary of Word Meanings”, by Hristo Georgiev, published by Nova Science, New York, 2010, Series: (Languages & Linguistics Series). ISBN: 1608763919: 9781608763917

4. Semantische Information und Arten Ihrer Messung, H. Georgiev, co-author: R. G. Piotrowskij, in: ZEITSCHRIFT FÜR PHONETIK, SPRACHWISSENSCHAFT und KOMMUNIKATIONSFORSCHUNG, B. 28, Heft 2, pp. 221-235, 1975, Berlin, in German.

5. A New Method of Measuring Meaning, H. Georgiev, co-author: R. G. Piotrowskij, in: LANGUAGE AND SPEECH, vol. 19, part 1, 1976, pp. 41-45, London, in English.

6. Automatic Recognition of Verbal and Nominal Word Groups in Bulgarian Texts, H. Georgiev, in: t.a. Informations, REVUE INTERNATIONAL DU TRAITMENT AUTOMATIQUE DU LANGAGE, Dix-septieme anee, No 2, 1976, pp. 17-24, Grenouble, France, in English.

7. Brief Lexico-Semantical Description of the Subject Field “Oil and Gas”, H. Georgiev, in: t.a. Informations, REVUE INTERNATIONAL DU TRAITMENT AUTOMATIQUE DU LANGAGE, Vingtieme anee, No 1, 1979, pp. 47-59, Grenoble, France, in English.

The German and French Sequences of Parts of Speech, used in the procedure of the invention are published in the book “Language Engineering”, page 280, 289-301.

The book describes, in detail, the morphological analysis of the word, the syntactical analysis of the sentence, the grammatical analysis of the sentence and content recognition.

The English Sequences of Parts of Speech, used in the procedure of the invention are described and partially published in the book “English Algorithmic Grammar”, page 44-207.

The word reference and the Pronominal Reference, used in the procedure of the invention are described and published in the book “English Algorithmic Grammar”, page 208-219.

The role of the semantic codes to understand the meaning of the sentence, was first mentioned in the book “English Algorithmic Grammar”, page 231-.236.

The semantic word groups and their codes, used in the procedure of the invention, were published in the book “Dictionary of Word Meanings”.

Dictionary No 3, used in the procedure of the invention, was published in the book “Dictionary of Word Meanings”, in the Appendix.

Other publication on novel information:

1. “How Effective is Query Expansion for Finding Novel Information”, by Min Zhang, Chuan Lin and Shaoping Ma, State Key Lab of Intelligent Tech. and Sys., Tsinghua University, Beijing, 100084, China.

### (h) BRIEF SUMMARY OF THE INVENTION

### DESCRIPTION OF THE INVENTION

General Scheme Representing the Steps Needed to Realize the Invention:

1. Input, newly written sentence or text. Analysis of the sentence or the entire text, sentence by sentence, to determine the morphological structure of the word and the syntactical structure of the sentence, hence, to determine the contextual meaning of each constituent word and its reference to other words in the same sentence or in the previous sentence(s). In case of complex or compound sentence, separation of the syntactically and semantically independent units, such as Adverbial or Prepositional phrases, dependent and independent Clauses, etc.

2. Paraphrasing the sentence, by preserving its original meaning.

3. Finding the implicit information contained in the sentence.

4. Replacing the contextual meaning of each word with a code. As a result, the sentence will be turned into sequence of Auxiliary Words and semantic codes, marking the meaning of each word.

5. Comparing the coded sentence with the existing coded sequences in the database.

6. When a matching coded sequence is found, the coded sequence of the newly entered sentence is deleted. This sentence is not entered in the Database. because it contains no new information.

7. When a matching coded sequence is not found in the Database, the coded sequence of the sentence, under analysis, is entered in the Database, as new information.

8. The System displays the newly entered coded sequence as a sequence of Natural Language words, by replacing the codes with words.

9. Since the codes can represent a whole group of words, with identical or very similar meaning, the System will display all possible combinations of these words as probable variants of the same sentence.

### (i) BRIEF DESCRIPTION OF THE SEVERAL VIEWS OF THE DRAWING(S)

There are no drawings.

### PROBLEM SOLVED BY THE INVENTION AND SOLUTION TO THIS PROBLEM

A database, containing Natural Language written texts is always incomplete, without the latest what is written and published. Storing written information, all the time, leads to information explosion, which is the case now and a major problem for those who use the stored written information to fmd what they do not know already. Our System presents a solution to this problem, by filtering out the new information and presenting this new information to the user.

If the incoming information, contained in the written sentences already exists in the database, there is no need to record and store it again and again. As a result, it will be easier to fmd the information we need and the information explosion will be slowed down.

### (j) DETAILED DESCRIPTION OF EMBODIMENTS OF THE INVENTION

Machine readable media to find new information in Natural Language sentences.
1 . Enter (type in) a sentence for analysis.
2. Paraphrase the sentence, preserving its meaning (see example 1).
3. Find the implicit information in the sentence, using the procedure described in LOGIFOLG, U.S. Pat. No. 8,560,305 B1, published on Oct. 15, 2013 and the program LOGIFOLG, developed upon this procedure. Print the implicit information, as shown in example 2.
4. Send the original sentence, its paraphrased variant(s) and the sentence with the implicit information for analysis in step 5.
5. Run each word of the original sentence, each word of the paraphrased variant(s) and each word of the sentence with the implicit information through Dictionary No 1 to find a matching word.
6. When a matching word(form) is found, replace the word(form) with its Part of Speech sign, by parsing the sentence with Natural Language Parser to determine the conterxtual Part of Speech for each word(form), as shown in example 3.
7. Run the Part of Speech sequence of the sentence through Dictionary No 2, as explained in example 4, in order to fmd a matching sequence.
8. When the sequences of Parts of Speech are matched, the sentence is separated into segments, see example 5. Store, temporarily, the segments for further operation with them. Go to 9.
9. Run each word(form) of the original sentence, each word of the paraphrased variant(s) and each word of the logical inferences, made upon the original sentence, through Dictionary No 3, as shown in example 6.
10. When a matching word(form) is found, replace the word(form) with its semantical code, by following the instruction given in 10a), in order to form a sequence of semantic codes, corresponding to the length of the segment. See example 6.
10a) Instruction to select only one code, in case the word(form) has more than one code.
   Eliminate codes starting with 4 and 6.
   Prefer codes starting with 1 to codes starting with 2 and 5.
   Prefer codes starting with 3 to codes starting with 1, 2 and 5.
Store the sequence of codes for further operations with them. Go to 11.
11. Take the semantical codes of each word(form) of the original sentence, of each word of the paraphrased variant(s) and of each word of the logical inferences and match them with the sequences of semantical codes already stored in the Database of the System. See example 7. Go to 12a).
12a) If the original sentence, the sentence under current analysis, is the first ever sentence, analysed by the System, there are no matching codes stores in the Database. In this case, all the information, contained in the sentence, is a new information. Print “New information”. Print the sentence and its variant(s).

If the original sentence s not the first sentence analysed by the System, go to 12b)
12b) If there are already sequences of semantical codes stored in the Database of the System from the analysis of previous sentences and texts, run the code sequence of the original sentence, of the paraphrased variant(s) and of the logical inferences through the code sequences stored in the Database of the System. as shown in example 7. Go to 12ba) if match is found. Go to 12bb) if no match is found.
12ba) If all code sequences fmd a match in the Database, print
   “No new information found”.
12bb) If the code sequence of the original sentence, of the paraphrased variant(s) and of the logical inferences finds no match in the code sequences already stored in the Database of the System, list the sequence of semantical codes in Dictionary No 4. Print “New information”. Transform the codes into Natural Language words. Print the sequence of Natural Language words after spell checking them with a grammatical spell-checker, such spell-checker that will automatically agree the words in Number, Case, Gender, as needed.

Dictionaries used by the Computer System

1. Dictionary No 1, word to Part of Speech Dictionary. This is alphabetically ordered word(forms) and the Part of Speech they belong to when out of context. See the example below.

...............................................
betimes*D
betoken*V
betony*N
betook*h
betray*V
betrayal*N
betroth*V
betrothal*N
betrothed*A
bets*z/n
betted*E
better*Z/N/A
betterment*N
. . . . . . . . . . . . . . . . . . . etc.

where D is an Adverb, V is a Verb, N is a Noun, h is Past Tense of the Verb, A is an Adjective, z/n is either Verb or Noun, third person, E is Past Tense of the Verb or Past Participle, Z/N/A is either Verb or Noun or Adjective, etc. entry words and their Part of Speech abbreviations.

2. Dictionary No 2, Dictionary of Segments, a Dictionary of all possible sequences of Parts of Speech within the sentence.

...........................................
T N V T A N to V T A N
T N V T A N to V T N
T N V T A N to V N
T N V T A N to V M
T N V T A N to V M up
. . . . . . . . . . . . . . . . . .
Pi A N are T N
Pi A N are also T N
. . . . . . . . . . . . . . . . .
N V to N by N
. . . . . . . . . . . . . . . .
N V by N to N
etc.,

where T is an Article or Indicative Pronoun, N is a Noun, V is a Verb, to is a Verbal Particle or Preposition, depending on context, up is the adverbial part of a Compound Verb, representing a number of Auxiliary words in this role, M is a Personal Pronoun, Objective Case, Pi is -ing Participle, are is an Auxiliary Verb of be Paradigm, also stands for a number of Adverbs and Conjunctions, by is a Preposition.

Additional sequences:

. . . . . . . . . . . . . . . . . . . . . . . . . . . . .

| | | | | | | |
|---|---|---|---|---|---|---|
| N | V | to | N | by | N | |
| N | V | to | N | Pi | A | N |
| N | V | to | N | Pi | N | |

. . . . . . . . . . . . . . . . . . . . . . . . . . .

3. Dictionary No 3, A Dictionary of word(form) and its semantical code(s).

Below is an example how this Dictionary looks.

.............................................
extract=3KQ/5CDW′/
extraditable=5BEA/
extradite=2NC-C/5BEA′/6AB/
extradition=5BEA/
extramarital=5ATE/
extraneous=2MF-A/5AAU/
extraordinarily=5DMW/
extraordinary=5DMW/5DNN/
extrapolate=5CPP/
extrapolation=5CPP/
extraterrestrial being=2BD-C/
extraterrestrial=4SI/5CEY/
extravagance=5AYZ/
extravagant=5AYZ′/6UT/
extravaganza=3GI/
extreme=3CN/6UT/
extremely=5BLH/
extremism=2EJ-B/
extremist=2EJ-B/6XY/
extricate=1IS/2QU-A/2QU-C/
extrication=1IS/2QU-C/
extrinsic=2MF/
extroversion=2LY-M/
extrovert=2LY-M/6TU
...................................................

Codes starting with 1, and 5 group together synonyms that are context independent, that means, each synonym can be used, in this context, preserving the original meaning of the sentence. Codes starting with 2 and 3 group together words that are not necessarily synonyms, but can be replaced, in any context, with one word, with general meaning, for example, the word “get” can replace such words as obtain, receive, reach, etc. The group with code 2 is hierarchically structured, the word on top of the tree is a concept. Code 4 groups together words that belong to the same subject field. Code 6 is most general, it groups words meaning “positive” or “negative” or “time”, etc.

4. Dictionary No 4. Dictionary of sequences of semantical codes and their meaning, expressed in Natural Language.

List of all sequencies of semantic codes stored in the System:

..............................................
2SA/OO/O/RI-A = Somebody hit his (her) head
2SA/am/DG/to/BFC/T/GZ-A = Somebody is asked to head the delegation
2SA/5CLA/in/2AV-L = Somebody arrived in Switzerland
2SA/IF/ LQ = People eat food
2QY-ABB/2NA-C = Peter went
to/2FD = To school
by/2FY-A = By car
.................................................etc.

Dictionary No 5, code to word dictionary, used by instruction 12bb to transform the codes into Natural Language words:

.............................................
1IS =extricate
1IS =extrication
2BD-C=extraterrestrial being
2EJ-B=extremism
2EJ-B=extremist
2LY-M=extroversion
2LY-M=extrovert
2MF=extrinsic
2MF-A=extraneous
2NC-C=extradite
2QU-A=extricate
2QU-C=extricate
2QU-C=extrication
3CN=extreme
3GI=extravaganza
3KQ=extract
5AAU=extraneous
5ATE=extramarital
5AYZ=extravagance
5AYZ=extravagant
5BEA =extradite
5BEA=extraditable
5BEA=extradition
5BLH=extremely
5CDW′=extract
5CEY=extraterrestrial
5CPP=extrapolate
5CPP=extrapolation
5DMW=extraordinarily
5DMW=extraordinary
..................................................

### EXAMPLES USED BY THE MACHINE READABLE MEDIA

### Example 1

### Sentence and Its Equal Paraphrased Variant(s)

John saw Ann=Ann was seen by John.

John is bigger than Peter=Peter is smaller than John.

Peter went to school by car=Peter went by car to school.

The paraphrasing is done automatically, by a computer software program, described in detail in our patented invention to find implicit information in the sentence.

### Example of C/C++ Programming Code Used by Our System to Paraphrase the Sentence

case 132:

if (!stricmp(wrdp−>inword, “is bigger than”)) {

printf(“\%s\ is smaller than ”, wrdm−>inword);
printf(“\%s\. \n”, wrd−>inword);

}
if (!stricmp(wrdp−>inword, “is smaller than”)) {

printf(“\%s\ is bigger than ”, wrdm−>inword);
printf(“\%s\. \n”, wrd−>inword);

}

CopySyn( );
i = mpos; continue;

(“[NR]XN”, NULL,132}, // bigger than

### Example 2

### Implicit Information in the Sentence

Original sentence: John bought a new Fiat.

Implicit information: John has a new car.

### Example of C/C++ Programming Code Used by Our System to Find Implicit Information in the Sentence

case 235:
if (wrd−>E.W.human == 1 && wrd−>next−>E.W.take == 1 &&
wrd−>next−

>E.W.not_specified1 == 1 && wrdm−>E.W.vehicle == 1) {

if (wrd−>numb == 1) {
printf(“ \%s\ have a ”, wrd−>inword);

printf(“\%s\ car.\n”, wrdm−>inword);

```
  }
if (wrd−>numb != 1) {
  printf(“ \%s\ has a ”, wrd−>inword);
```

printf(“\%s\ car.\n”, wrdm−>inword);

}
}
i = mpos; continue;

(“[NR][ZVEhue]<Ta>[ASON]N”, NULL, 235}, // bought a Fiat =
has a car

### Example 3

### A Sentence and Its Sequence of Parts of Speech

They went on with their work
R V on with O N
   where R is a Personal Pronoun, V is a Verb, O is a Possessive Pronoun, N is a Noun.

Note, that the sentence is parsed with a Natural Language Parser, to determine the contextual Part of Speech. Some Auxiliary Words are kept as they are, they are not replaced with a code sign, because they play an important role in the division of the sentence into segments. The segments are syntactically and semantically, relatively, independent units within the sentence. Their future role is only to divide the sentence into relatively independent units, which later, will be filled with semantic codes.

### Example of C/C++ Programming Code Used by Our System to Determine the Sequence of Parts of Speech in the Sentence

{“[NR][ZVEhue][NOM]AN”, NULL, 239}, //Noun-Verb-Noun/Pron.-Adj.-Noun and to print it:

#if defined(_SOFT) && defined(_DEBUG)

wnprintf(“\n PS=%s\n”,synstr);

wnprintf(“\n PS=%s\n”,synstf);

#endif

### Example 4

### Matching of Parts of Speech Sequences

```
The woman asked the man to watch the dog.
  T N V T N to V T N
will match the second line in Dictionary No 2.
Peter went to school by car.
  N V to N by N
Peter went by car to school.
  N V by N to N
will match the last to sequences in Dictionary No 2.
Peter went to school by bus.
```

N V to N by N

Peter went to school by train.

N V to N by N

Peter went to school using public transport.

N V to N Pi A N

Peter went to school using transport.
N V to N Pi N

will match the additional sequences, where
Peter went to school using public transport
   will be the logical inference made upon the first two sentences,
Peter went to school using transport
   will be the logical inference made upon the first three sentences.

Note, that to school is ambiguous, it can be a Verb, the Natural Language Parser must parse it correctly in order to determine its role in this context.

### Example of C/C++ Programming Code Used by Our System to Determine the Sequence of Meanings in the Sentence

case 210:
if (wrd−>E.W.human == 1){

```
  if (wrdm−>E.W.vehicle == 1) {
  printf(″\%s\ used transport.\n″, wrd−>inword);
  }
}
i = mpos; continue;
```

(″[NR]<vzVEhPNBTNZ>‘by‘N″, NULL, 210), // by transport

Our System can differentiate whether it is public transport or private transport, also, if it is by boat, by air, by car, by train.

### Example 5

### Segments Obtained After Matching the Parts of Speech Sequences

```
Peter went / to school / by car.
  N V / to N / by N
Peter went /by car /to school.
  N V / by N /to N
```

where the forward slash marks the borders of the segment.

### Example 6

### A Procedure to Replace the Word(s) and the Wordform(s) of the Sentence with Their Semantical Codes

Below is an example how this Dictionary looks.

.............................................
extract=3KQ/5CDW′/
extraditable=5BEA/
extradite=2NC-C/5BEA′/6AB/
extradition=5BEA/
extramarital=5ATE/
extraneous=2MF-A/5AAU/
extraordinarily=5DMW/
extraordinary=5DMW/5DNN/
extrapolate=5CPP/
extrapolation=5CPP/
extraterrestrial being=2BD-C/
extraterrestrial=4SI/5CEY/
extravagance=5AYZ/
extravagant=5AYZ′/6UT/
extravaganza=3GI/
extreme=3CN/6UT/
extremely=5BLH/
extremism=2EJ-B/
extremist=2EJ-B/6XY/
extricate=1IS/2QU-A/2QU-C/
extrication=1IS/2QU-C/
extrinsic=2MF/
extroversion=2LY-M/
extrovert=2LY-M/6TU
...................................................

Additional rule in the System instructs the computer software program to select only one code, in case the word(form) has more than one code. The selection of the right code, in this case, is done by instruction 10a). This instruction eliminates the unnecessary codes and leaves only one code, most relevant for this context. For example irrelevant codes are those starting with number 4 or number 6. Number 4 marks a Subject Field. Number 6 marks a sem, present in hundreds, even in thousands of words, for example “negative”, “positive”, etc. Codes starting with 1 are preferred when the word(form) has codes starting with 2 and 5. Codes starting with 3 are used when the word(form) has no codes starting with 1, 2 or 5. As a result of the operation carried out by 10a), the sentence in example 5 will assume the following codes:

Peter=2QY-ABB
went=2NA-C
to=to
school=2FD
by=by
car=2FY-A

The semantic codes observe the boundaries of the segments, therefore the code sequences will be the same as the segment sequences, such as:

| segment | codes |
|---|---|
| N V | 2QY-ABB/2NA-C |
| to N | to 2FD |
| by N | by 2FY-A |

### Example of C/C++ Programming Code Used by Our System to Recognize the Meaning of a Word in the Sentence and to Print its Semantic Code

if (!stricmp(wrd−>inword, “burned”) || !stricmp(wrd−>inword,

“scorched”) || !stricmp(wrd−>inword, “smouldered”) ||
!stricmp(wrd−>inword,
“seared”) || !stricmp(wrd−>inword, “singed”) ||
!stricmp(wrd−>inword, “charred”) || !stricmp(wrd−>inword, “reduced to
ashes”) || !stricmp(wrd−>inword, “guttered”) ||
!stricmp(wrd−>inword, “kindled”) || !stricmp(wrd−>inword, “branded”) ||
!stricmp(wrd−>inword, “incinerated”) || !stricmp(wrd−>inword, “flamed
up”)
|| !stricmp(wrd−>inword, “cremated”) || !stricmp(wrd−>inword,
“cauterised”)
|| !stricmp(wrd−>inword, “cauterized”) || !stricmp(wrd−>inword,
“blazed”)
|| isflex(wrd−>inword, wrd−>wl, “burned”) || !stricmp(wrd−>inword,
“burnt”)
|| isflex(wrd−>inword, wrd−>wl, “burnt”)) {
printf(“ \\%s\\=> the code of burn\n”, wrd−>inword);
}

### Example 7

### Matching Sequences of Semantical Codes Belonging to the Sentence Under Analysis and its Variant(s) with Existing Semantical Codes, Obtained from the Analysis of Previous Sentences

List of all sequencies of semantic codes stored in the System:

..............................................
2SA/OO/O/RI-A = Somebody hit his (her) head
2SA/am/DG/to/BFC/T/GZ-A = Somebody is asked to head the delegation
2SA/5CLA/in/2AW-J = Somebody arrived in Switzerland
2SA/IF/ 2LQ = People eat food
2QY-ABB/2NA-C = Peter went
to/2FD = To school
by/2FY-A = By car
.................................................etc.

where “somebody”, “people” stand for all words denoting a human being. All words denoting a human being can assume this position; “am” replaces all words from the “be” paradigm, “head” used as Verb or Noun has different codes for Verb and for Noun, 2AW stands for any Western country, 2LQ stands for any type of food, 2FD stands for any Educational Institution, 2FY stands for any engine propelled vehicle. The sub-categories are shown after the dash (-). The sentence from example 5, with its semantical codes in example 6, will match the last three sequences of semantic codes. All possible variants of this sentence will match the same sequences. For example:

Peter went to school by car.
By car Peter went to school.
To school Peter went by car.
By car to school Peter went.
To school by car Peter went.

Peter went (2QY-ABB/2NA-C) to school (to/2FD) and by car (by/2FY-A) will probably exist in the Database, therefore they will not contain new information, on their own. They will contain new information only when used together, as shown in the paraphrased example above, if not registered in the Database as a coded sentence.

For example, if we have already registered in the Database “Peter went to school”, Peter went by car”, these sentences will not contain new information. If the sentence is “Peter went to school by car”, this sentence will contain new information and will be registered in the Database, despite the fact that the Database contains already “Peter went to school”, “by car”, as separate entries.

1. A computer implemented method of creating an automated system in machines and computer based software applications for finding new, novel, information in written natural language sentences comprising the steps of
(a) a computer processor, linked to user, who types in a written text, sentence or sentences, with a request this written text to be analysed, sentence by sentence, in order to fmd new information in it,
(b) whereas the computer processor reads the user's written sentence, understands its meaning by analysing successive and non-successive words, up to six words in a sequence, within the sentence or the clause,
(c) whereas the computer processor finds unknown, new, novel, information, which is not contained in the knowledge database of the system; and
(d) the computer based software application is a computer software process for analysing the text, sentence after sentence, understanding the meaning of the sentence, searching to fmd identical meaning, already stored in the database of the system, and when no identical or very similar meaning is found, displays the new information contained in the sentence, in written form, and,
thereafter, codes the new information and stores it in the knowledge database, whereas, once stored in the knowledge database, the new information is no longer new information, it is information known to the system.

2. An automated, intelligent, computer system having a database of coded information, comprising:
(a) a computer processor linked to one or more users
wherein the computer processor can receive the user's written input; and
(b) an automated intelligent system which is controlled by the computer processor,
wherein the automated intelligent system has a machine program code,
wherein the machine program code is executable to perform a reasoning process,
wherein the reasoning process is tied to a database of words with coded information,
wherein the coded information comprises part-of-speech information, including morphological, grammatical, syntactical and semantical information,
wherein the reasoning process is tied to a built-in semantic representation of word meanings and their relationships,
wherein the automated intelligent system analyses user's written input,
wherein the automated intelligent system understands the grammatical and syntactical structure of user's written input and its meaning,
wherein the automated intelligent system finds new, novel, information in users written input,
wherein the automated intelligent system displays the new information,
wherein the displayed new information can be used further by other, internal or external machines, for other tasks.
